(19) United States
(12) Patent Application Publication
(10) Pub. No.: US 2026/0227849 A1
(43) Pub. Date: Aug. 6, 2026

(54) EYE TRACKER MODULE, EYE TRACKING METHOD AND EYE TRACKER SYSTEM

(71) Applicant: ams-Osram International GmbH, Regensburg (DE)

(72) Inventors: Ulas ADIYAN, Zürich (CH); Giacomo COLZI, Rüschlikon (CH); Pierre-Yves TALOUD, Annecy le vieux (FR); Javier MIGUEL SÁNCHEZ, Zürich (CH)

(21) Appl. No.: 19/156,419

(22) PCT Filed: Feb. 13, 2024
(86) PCT No.: PCT/EP2024/053592

§ 371 Date: Aug. 14, 2025

(30) Foreign Application Priority Data
Feb. 15, 2023 (DE) 10 2023 103 688.2

(51) Int. Cl. G06F 3/01; G06T 7/73

(52) U.S. Cl. CPC G06F 3/013; G06T 7/74; G06T 2207/30201

(57) ABSTRACT

In at least one embodiment, the eye tracker module (100) comprises a radiation unit (1) and a detection unit (2). The radiation unit is configured to project a 2D-structured pattern (PI) onto an eye (3) of a user. The detection unit is configured to capture an image (DI) of the 2D-structured pattern as reflected by the eye.

An eye tracker module, an eye tracking method and an eye tracker system are specified. Furthermore, a display device, a method for operating a display device, a computer program and a computer readable data carrier are specified.

Eye trackers play a significantly important role for Augmented Reality (AR) applications, for example. AR glasses or other head-mounted devices with a near eye display system offer a variety of possibilities for consumers in applications related to education, gaming and service industry. These near eye display systems are typically light-inefficient in terms of power efficiency. In addition, large field of view and large exit pupil (or eye box) are required to ensure that the display content is captured by the retina of the user. Eye trackers are extremely useful in improving the light efficiency of the displays and reducing the exit pupil of the display system by dynamically steering the exit pupil based on, for example, the pupil center location of the user. This not only improves light efficiency but may also enhance a natural imaging experience to the user through foveated rendering with AR near eye display.

One object to be achieved is to provide an improved eye tracker module, e.g. an eye tracker module which enables reliable recognition of the pupil of a human eye. Further objects to be achieved are to provide an improved eye tracking method and an improved eye tracker system. Additional objects to be achieved are to provide a display device with such an eye tracker module, a method for operating such a display device and a computer program as well as a computer readable data carrier for operating the eye tracking system.

First, the eye tracker module is specified.

According to at least one embodiment, the eye tracker module comprises a radiation unit. The radiation unit is configured to project a 2D-structured pattern onto an eye of a user.

When the eye is at a nominal operation distance to the eye tracker module, the 2D-structured pattern projected onto the eye comprises, for example, a plurality of illuminated features or radiation spots, respectively, which are distributed over the eye in a two dimensional manner and which are spaced from each other. The features may be distributed over the eye, particularly over the pupil, the iris and optionally the sclera. For example, when the eye is within a nominal operation distance, at least ten or at least 20 or at least 100 such features are projected onto the pupil and the iris. The area between each two such features is, for example, not illuminated by the radiation source or illuminated with a lower intensity. For example, each feature projected onto the eye has a size of at most 4 mm² or at most 1 mm².

According to at least one embodiment, the eye tracker module comprises a detection unit. The detection unit is configured to capture an image of the 2D-structured pattern as reflected by the eye. This means, in particular, that the captured image comprises information which is representative for the positions of the features of the 2D-structured pattern which are reflected at the eye. Additionally, the image may comprise information which is representative for the brightness or luminance or radiance, respectively, of the features reflected at the eye.

The eye tracker module may comprise two or more radiation units and/or two or more detection units. All features disclosed herein in connection with one radiation unit are also disclosed for all other radiation units. Likewise, all features disclosed in connection with one detection unit are also disclosed for all other connection units.

In at least one embodiment, the eye tracker module comprises a radiation unit and a detection unit. The radiation unit is configured to project a 2D-structured pattern onto an eye of a user. The detection unit is configured to capture an image of the 2D-structured pattern as reflected by the eye.

Existing eye tracker solutions, particularly pupil tracker solutions, detect the pupil center by fitting a circular or elliptical geometry on the pupil. However there are technical problems with these solutions. For example, the pupil detection does not perform correctly with elliptical pupils (e.g. when the pupil is located at the corners of the image) or when there is an occlusion of the pupil with the eye lashes or eyelids (i.e. it is hard to define the boundary of the pupil) or when there are corneal reflections or additional light sources in the environment (e.g. corneal reflections make it hard to find the boundary of the pupil). Moreover, the computational load (i.e. computation time and power) on the complex fitting algorithms is high.

With a 2D-structured pattern projection and the corresponding capturing of an image no complex fitting algorithm is necessary, but good performance for corner cases of the pupil is still achieved, for example.

According to at least one embodiment, the radiation unit is configured to project a 2D-dot pattern and/or a 2D-square pattern and/or a 2D-stripe pattern and/or a 2D-elliptical pattern onto the eye. This means that the projected features have the form of dots or squares or stripes or ellipses, for example.

According to at least one embodiment, the radiation unit is configured to project a regular 2D-structured pattern. This means that when the 2D-structured pattern is projected onto a flat surface being at a nominal operation distance from the eye tracker module, the features are arranged regularly, e.g. on grid points of a rectangular grid.

Alternatively, the radiation unit may be configured to project an irregular 2D-structured pattern.

According to at least one embodiment, the features of the 2D-structured pattern have varying forms and/or sizes. That is, when the 2D-structured pattern is projected onto a flat surface which is at a nominal operation distance to the eye tracker module, the sizes and/or forms of the features vary. This may help to better identify and distinguish the features in the captured image.

According to at least one embodiment, the radiation unit is a projector. For example, the radiation unit comprise at least one radiation source, i.e. one or more radiation sources.

Each radiation source may comprise or may be an optoelectronic semiconductor chip. The projector may further comprise an optical system arranged downstream of the at least one radiation source in order to focus the radiation from the radiation source onto the eye of the user. The optical system may comprise one or more lenses, for example.

According to at least one embodiment, at least one radiation source comprises a VCSEL. For example, at least one radiation source is a VCSEL array. This allows the intensity emitted by the radiation unit to be tuned. Additionally or alternatively, at least one radiation source may comprise or may be one or more LEDs.

According to at least one embodiment, the radiation unit comprises at least two radiation sources. One radiation source may be configured such that a 2D structured pattern is projected onto the eye during its operation, and another radiation source may be configured such that flood radiation is projected onto the eye during its operation. Both radiation sources may be VCSEL arrays, for example.

According to at least one embodiment, the radiation unit comprises a micro lens array. The micro lens array may be configured to project a 2D-structured pattern onto the eye of the user when illuminated with radiation from a radiation source of the radiation unit. Additionally or alternatively, the radiation unit may comprise a wafer level optics.

According to at least one embodiment, the detection unit is a camera. For example, the detection unit comprises an image sensor, like a CCD sensor or a CMOS sensor. The detection unit may further comprise an optical system arranged upstream of the image sensor in order to focus the radiation reflected from the eye onto the image sensor. The optical system may comprise one or more lenses.

According to at least one embodiment, the dimensions of the radiation unit in any direction are at most 10 mm or at most 5 mm. Likewise, the dimensions of the detection unit in any direction may be at most 10 mm or at most 5 mm.

According to at least one embodiment, the radiation unit is configured to emit radiation in the visible wavelength range and/or IR radiation, particularly near IR radiation.

Likewise, the detection unit may be configured to detect radiation in the visible wavelength range and/or IR radiation, particularly near IR radiation.

According to at least one embodiment, the eye tracker module comprises at most two radiation units or exactly one radiation unit. Likewise, the eye tracker module may comprise at most two detection units or exactly one detection unit.

According to at least one embodiment, the detection unit comprises a wavelength filter, particularly a bandpass wavelength filter. The filter is, for example, configured to let pass radiation of a certain wavelength range which matches with the wavelength range emitted by the radiation unit 1 and reflects or absorbs radiation outside this certain wavelength range, e.g. ambient light.

According to at least one embodiment, the eye tracker module is formed as a package which is mountable to a display device. Additionally, it may be signally connectable to the display device. In other words, the eye tracker module realizes a composite of its elements, particularly of the radiation unit and the detection unit, which may be fixed in position relative to each other and this composite is mountable to a display device as a unit or as a whole, respectively. The eye tracker module as a whole can be handled and/or transported independently of a display device and can be mounted, as well as signally connected, to the display device. In other words, the eye tracker module is a monolithic and/or self-standing module.

“Signally connected” herein means that the eye tracker module can be connected to the display device such that (electronic) signals, like the captured image or a determined information being representative for the pupil position, can be exchanged between the eye tracker module and the display device. For example, the connection for establishing the signal exchange may be a wireless or wired connection.

For example, the eye tracker module comprises mechanical connection means, like clips or through-holes, for mechanically connecting the eye tracker module to the display device. Additionally, the eye tracker module may comprise electrical connection means, like terminals, for electrically connecting the eye tracker module to the display device.

A display device may herein be, for example, a PC, a notebook, a tablet PC, a smart phone or a head-mounted display device, like AR-glasses or VR-glasses or a helmet.

The display device could also be the dashboard of a vehicle. Realizing the eye tracker module as a package or composite, respectively, which can be separately handled and mounted as a whole to a display device, like AR-or VR-glasses. Such an eye tracker module can be provided with a very small form factor. On the other hand, such an eye tracker module may be immune to slippage of such glasses, for example.

According to at least one embodiment, the footprint of the eye tracker module is at most 10-times larger or at most 5-times larger than the footprint of the radiation unit and/or of the detection unit. For example, the footprint of the eye tracker module is at most 300 mm² or at most 200 mm² or at most 100 mm² or at most 50 mm². The footprint of the eye tracker module is, in particular, the area of a mounting surface of the eye tracker module. The mounting surface is the surface which is mounted to the display device, i.e. which faces the display device. For example, the footprint is the area of the eye tracker module when the eye tracker module is viewed in a top view, wherein the top view is a view parallel to that main radiation emission direction of the radiation unit.

According to at least one embodiment, the radiation unit and the detection unit are arranged such that, with the eye tracker module being at a nominal operation position with respect to an eye of a user, the radiation from the radiation unit being reflected by the eye and then being detected by the detection unit mainly results from Lambertian reflections at the eye. In this context, arranged means spatially arranged or geometrically arranged, respectively. For example, at least 80% or at least 90% of the detected radiation results from Lambertian reflections. For example, the contribution in the detected radiation resulting from specular reflections is at most 20% or at most 10%. This contribution from the specular reflections may appear in a different form as compared to the spatial extent of the projected pattern (e.g. as bright glints, small portion of the pattern combined or separated in a various different shapes than the standard pattern). It may also appear differently in terms of light power captured by the camera as compared to contributions from Lambertian reflections. These contribution from specular reflections may change with the eye position and gaze angle.

Lambertian reflections are ensured, for example, due to the small footprint of the module and the accordingly small distance between the radiation unit and the detection unit. Avoiding specular reflections and ensuring Lambertian reflections means, particularly, that the reflections mainly come from the bottom layers of the eye, e.g. the iris and the sclera, rather than from the cornea. This may be particularly advantageous if the eye tracking is done with help of a projected 2D-structured pattern.

The residual contribution of specular reflections on the eye is limited to a reflection from a small portion of the cornea. This small portion depends on the position of the radiation unit and the detection unit with the position of the eye. Given the above conditions, the number, shape, size and total spatial extent of such reflections is limited by the small footprint of the sensor to a small area of the full image.

Indeed, a 2D-structured pattern projection and the corresponding capturing in combination with Lambertian reflections enables a reliable determination of the pupil location. This is because features projected onto the pupil may be less reflected than features projected onto the iris or may not be reflected at all, which allows the (center) position of the pupil to be detected. Indeed, since the Lambertian reflections mainly result from the bottom layers of the eye, the information extractable from the captured image is, in particular, representative for the structure of the iris, the pupil, the sclera and so on.

The nominal operation position is, for example, a position in which the eye tracker module is at a nominal operation distance from the eye. The nominal operation distance is, for example, a distance which is at least 2-times or at least 5-times or at least 10-times larger than the distance between the radiation unit and the detection unit. The nominal operation distance is, for example, between 1 cm and 20 cm, particularly between 1 cm and 10 cm. For example, when the display device is glasses, the nominal position may be a position at the frame of the glasses.

According to at least one embodiment, the radiation unit and the detection unit are mounted on a common carrier.

Particularly, the radiation unit and the detection unit may both be mounted on the top side of the common carrier. The radiation unit and/or the detection unit may be electrically connected to the common carrier. For example, lateral dimensions of the top side of the common carrier define the footprint of the eye tracker module. By way of example, the footprint of the eye tracker module is at most 10% or at most 5% greater than the top side of the common carrier.

According to at least one embodiment, the common carrier is a common circuit board, for example a common rigid PCB or a common flex PCB. Alternatively, the common carrier may be a common CMOS chip or a common CMOS substrate, respectively.

According to at least one embodiment, a distance between the detection unit and the radiation unit is at most 10 mm or at most 5 mm or at most 3 mm. Additionally or alternatively, the pitch between the detection unit and the radiation unit may be at most 10 mm or at most 5 mm or at most 3 mm. The pitch is, in particular, defined as the distance between the center of masses of the detection unit and radiation unit, or can be alternatively defined as the design distance between the optical axis and the main radiation direction of the detection and radiation units respectively, when parallel.

The distance and/or the pitch between the radiation unit and/or the detection unit is, for example, at most 2-times greater than the maximum lateral extension of the radiation unit or the detection unit. Herein, lateral directions are defined as directions parallel to the top side or main extension plane of the common carrier and/or perpendicular to the main radiation direction of the radiation unit.

According to at least one embodiment, the radiation unit and the detection unit are arranged in a common housing of the eye tracker module. The housing may laterally surround the radiation unit and the detection unit. For example, the housing laterally completely surrounds the radiation unit and the detection unit.

The housing may have a top side so that the radiation unit and the detection unit are arranged vertically between the top side of the housing and the top side of the common carrier. An aperture may be formed in the top side of the housing in order to allow the radiation from the radiation unit to exit the eye tracker module in the region above the radiation unit. Another aperture may be formed in the region above the detection unit in order to allow reflected radiation to enter the eye tracker module. The housing is, for example, opaque for the radiation of the radiation unit. Lateral dimensions of the housing deviate, for example, by at most 10% or at most 5% from the lateral dimensions of the common carrier.

According to at least one embodiment, the eye tracker module comprises a control unit or driver, respectively, for operating the radiation unit and/or the detection unit. That is, the control unit/driver is configured to operate the radiation unit and/or the detection unit. The control unit may be mounted and, optionally, electrically connected to the common carrier. Alternatively, the common carrier itself, particularly if it is realized as a CMOS chip, may constitute the control unit.

According to at least one embodiment, the control unit is configured to operate the radiation unit and/or the detection unit in a pulsed mode. This means that the control unit can operate the radiation unit such that it alternatingly emits more and less radiation. For example, the control unit is configured to operate the radiation unit such that it is alternatingly turned on and off. Particularly, this may be done periodically with a certain frequency. The frequency is, for example, at least 1 Hz or at least 10 Hz or at least 100 Hz.

Likewise, if the control unit is configured to operate the detection unit in the pulsed mode, it can operate the detection unit to repeatedly capture images, e.g. with the same certain frequency as the radiation unit is operated.

For example, the control unit is configured to operate the radiation unit and the detection unit in synchronized pulsed modes so that each time the radiation unit emits radiation, the detection unit captures an image, and during the periods when the radiation unit is turned off, the detection unit does not capture images.

Next, the display device is specified.

In at least one embodiment, the display device comprises at least one eye tracker module according to any of the embodiments described herein. The display device is configured to present the user of the display device with visible information.

Since the display device comprises at least one eye tracker module as specified herein, all features disclosed in connection with the eye tracker module are also disclosed for the display device and vice versa.

According to at least one embodiment, the display device comprises at least one or exactly one eye tracker module per eye of the user. That is, the display device may comprise at least two eye tracker modules.

According to at least one embodiment, the display device is a head-mounted display device, like AR-or VR-glasses.

According to at least one embodiment, the display device is configured to present the visible information at a display of the display device. Alternatively, the display device may be configured to project the visible information directly onto the eye of the user. The visible information may be a picture or a video.

According to at least one embodiment, the eye tracker module is signally connected to a host or processor, respectively, of the display device. The host/processor is, for example, configured to operate the display device such that it presents the visible information. For instance, the host is configured to operate the display device depending on a signal received from the eye tracker module.

Next, an eye tracking method is specified. The eye tracking method may be performed using the eye tracker module as specified herein. Therefore, all features disclosed in connection with the eye tracker module are also disclosed for the eye tracking method and vice versa.

In at least one embodiment, the eye tracking method comprises projecting a 2D-structured pattern onto an eye of a user with the help of a radiation unit, capturing an image of the 2D-structured pattern as reflected by the eye with the help of a detection unit and determining a gaze information depending on the captured image, wherein the gaze information is representative for the location of the pupil of the eye.

Particularly, the radiation unit and the detection unit may be the radiation unit and the detection unit of an eye tracker module as specified herein.

The eye tracking method is, in particular, a computer implemented method. For example, the step of determining the gaze information is performed by the control unit of the eye tracker module or by an external control unit.

The gaze information determined depending on the captured image is representative for the location of the pupil, particularly the location of the center of the pupil.

Additionally it may be representative for the gaze direction of the eye and/or for the eye rotation angle (or angles, depending on the exact representation-typically one for each rotational degree of freedom). The rotation angles can be defined based on the application convenience.

Illustratively and without loss of generality, rotation angles can be defined in polar coordinates, or by composition of rotations around reference orthogonal axes, or by Euler angles. For example, the gaze information determined depending on the captured image is representative for the gaze vector of the eye.

The eye tracking method may comprise a further step of generating an output signal. The output signal may be or may comprise the gaze information and may be configured to cause a host of the display device to operate the display device depending on the gaze information. The output signal is, for example, transmitted to the host of the display device. The output signal may be generated by the control unit of the eye tracker module.

According to at least one embodiment, the radiation unit and the detection unit are spatially or geometrically arranged such that the radiation from the radiation unit and detected by the detection unit mainly results from Lambertian reflections at the eye.

According to at least one embodiment, determining the gaze information comprises comparing the captured image of the 2D-structured pattern as reflected by the eye with a reference image. The reference image may be an image of a 2D-structured pattern, for example of a 2D-structured pattern which corresponds, or which is comparable, to the 2D-structured pattern projected onto the eye. For example, the reference image comprises information about the location and/or radiance of the features of the 2D-structured pattern of this reference image.

According to at least one embodiment, determining the gaze information comprises the step of identifying locations of features in the reference image for which corresponding features in the captured image have a radiance below a threshold or which are missing in the captured image in order to determine the location of the pupil.

Indeed, since the pupil is highly transmitting the radiation towards the retina, e.g. in the visible and/or the IR range, the features projected onto the pupil are back reflected to the camera only to a small amount (e.g. from cornea) or there might be no reflection at all. Therefore, by identifying the features with a radiance/brightness below a (predefined) threshold, or features which are missing in the captured image compared to the reference image, one can assume that these features lie within the pupil.

From the comparison between the captured image and the reference image, the center of the pupil may be determined.

Determining the center of the pupil may comprise determining the radiance weighted centroid of the identified missing features corresponding to the same location.

Determining the center of the pupil may comprise determining the difference image of the captured image and the reference image.

Determining the center of the pupil may comprise interpolation of the identified locations weighted with the radiance of the detected corresponding features. Thus, a feature that is fully invisible in the image is given a higher weight and effect in the pupil center computation compared to a feature that is only semi-visible, for example. Determining the center of the pupil may comprises a cross-correlation or an invert cross-correlation of the captured image with the reference image. This may help to highlight the missing features or the features with radiance below the threshold.

According to at least one embodiment, the reference image is updated depending on at least one image captured previously with the help of the detection unit. In other words, the reference image may be a previously captured image of the 2D-structured pattern as reflected by the eye, or may be determined based on such a previously captured image. For example, when starting the method, a certain reference image is used. Then, a 2D-structured pattern is repeatedly projected onto the eye while the eye is moving. At least some or all of these captured images are used to update/redetermine the reference image for a comparison to images captured later on.

According to at least one embodiment, the radiation unit is operated in a pulsed mode, e.g. with a certain frequency. For example, the radiation unit is repeatedly and periodically turned on and off. When turned on, the radiation unit may project a 2D-structured pattern and/or flood radiation onto the eye.

According to at least one embodiment, determining the gaze information is done depending on images captured in accordance with the pulsed mode. For example, only images are used for determining the gaze information which are captured when the radiation unit is turned on. It is also possible that the detection unit is also operated in a pulsed mode, e.g., with the same frequency as the radiation unit, so that images are only captured by the detection unit when the radiation unit is turned on.

By operating the radiation unit in the pulsed mode and determining the gaze information depending on images captured in accordance with the pulsed mode, static ambient background radiation can be rejected.

The operation of the radiation unit and/or the detection unit may be performed with the control unit being part of the eye tracker module or with a control unit which is external to the eye tracker module, e.g. which is part of the rest of the display device.

Next, the method for operating a display device is specified. The display device according to any one of the embodiments described herein may be operated with this method. Therefore, all features disclosed in connection with the display device are also disclosed for the method and vice versa.

In at least one embodiment, the method for operating a display device comprises executing the eye tracking method according to any one of the embodiments described herein and then presenting visible information to the user of the display device, depending on the determined gaze information.

For example, the visible information is presented at the region where the point of gaze of the user is positioned at that moment.

Next, the eye tracker system is specified.

In at least one embodiment, the eye tracker system comprises an eye tracker module according to any one of the embodiments described herein. The eye tracker system is configured to execute the eye tracking method according to any one of the embodiments described herein.

Since the eye tracker system comprises the herein described eye tracker module, all features disclosed for the eye tracker module are also disclosed for the eye tracker system and vice versa.

For operating the radiation unit and/or the detection unit and for determining the gaze information and, optionally, for generating the output signal, the eye tracker system may comprise one or more control units. One or more or all control units may be part of the eye tracker module, e.g. may be mounted on the common carrier of the eye tracker module. Particularly, the eye tracker module may be the eye tracker system. In other words, the eye tracker module may comprise all means for executing the eye tracker method or at least one mean for executing the eye tracking method is external to the eye tracker module.

Alternatively, one or more of the means, particularly control units, may be external to the eye tracker module, e.g. may be part of the display device.

The eye tracker system may comprise a memory for storing information, like captured images or reference images or the gaze information. This memory may be part of the eye tracker module or may be external to the eye tracker module.

Next, the computer program and the computer-readable data carrier are specified. The computer program comprises instructions to cause the eye tracker system described herein to execute the steps of the eye tracking method described herein. The computer-readable data carrier has stored the computer program thereon.

Additional features and supplemental explanations for different aspects described before, as well as further aspects of the invention are described in the following:

The eye tracker module comprises one or more detection units.
The detection unit may include an imaging optics (e.g. imaging lens, wafer level optics, pinhole arrays, microlens arrays) to image the target (e.g. eye) in the field of view of the detection unit with the projected pattern on top.
The detection unit may be used without an imaging optics by exploiting computational methods (e.g. lensless light field imaging etc.)
The detection unit may include an optical bandpass filter for capturing the wavelength of interest (e.g. near infrared, RGB, short wave infrared, etc.) and rejecting other wavelengths from ambient light.
The detection unit may be configured to provide images or videos of the target (e.g. eye, eyeball, pupil, iris) and the scenes to be transmitted to the host (e.g. the processor) for pupil detection computation.
For calibration or some other use cases, the images/videos or the processed data out of the images/videos can be kept in a memory of the eye tracker module or an external memory for other calculations.
The readout of the detection may be optionally adjusted to output static and/or dynamic images.
The readout of the detection unit may be adjusted only for dynamic images to reject static ambient light (i.e. AC coupled images or light pattern).
The readout of the detection unit may include many different ISP and post-processing algorithms, including but not limited to, gamma processing, HDR features, auto-exposure features etc.

The eye tracker module comprises one or more radiation units.
The radiation unit may include at least one or more than one radiation source (e.g. VCSEL emitter array, single VCSEL emitter, single LED or an LED array).
The radiation source may include projection optics (e.g. microlens arrays, wafer level optics, pinhole arrays, projecting lenses etc.)
The radiation unit may include a spacer from the VCSEL emitter array to the projection optics.
The eye tracker module and/or the radiation unit may include eye safety circuits configured to measure the electrical resistance of different radiation units or the whole module and/or may be configured to monitor radiation intensities using photon sensors (e.g. photodiodes, photodetectors) or elements, which can measure voltage or current.
The radiation unit and/or and the assigned optical system may include electrical traces for eye safety features.
The radiation unit may be configured to project a 2D-structured pattern (e.g. dot-pattern, stripe-pattern, line-pattern, square-pattern, elliptical-pattern etc.)
The radiation unit may be configured to project a regular 2D-structured pattern as a grid with equal spacing from one feature (e.g. dot) to the adjacent feature.
The radiation unit may be configured to project a pseudo-random/random 2D-structured pattern.
The eye tracker module may be configured to project dynamically changing 2D-structured patterns in time.
A further radiation unit may be configured to project 1D-or 2D-structured patterns or uniform flood radiation.
The eye tracker module may be configured to project dynamically toggling the structured light pattern and the uniform flood light.
The eye tracker module may be configured to simultaneously project the structured pattern and the uniform flood radiation.
The radiation unit may include projection optics to enable only structured pattern or only uniform flood radiation or both at the same time.
The radiation unit may include at least one connection to the control unit.
The radiation unit and one or more control units may be adjusted to generate DC projected radiation (100% duty cycle) as well as pulsed signal (AC projected radiation) at different frequencies.

The eye tracker module may comprise at least one control unit, also referred to as “driver” or “driver feature/circuit”, depending on the use case or implementation.
The control unit may be configured to drive the radiation unit(s) at an adjustable/programmable frequency and adjustable/programmable duty cycle as AC signals (e.g. square pulse signal) or at continuous mode (e.g. DC).
The radiation unit(s) may be used with external drivers/control units.
The eye tracker module may include features for adjusting the amplitude of the driving electrical signal for controlling the radiation intensity.
The eye tracker may include electrical connections to the radiation unit(s).
The eye tracker may include electrical connection from the radiation unit(s) and detection unit(s).
The eye tracker module may be configured to disable the radiation unit according to the input obtained from eye safety features.
The eye tracker module may be configured to synchronize the detection unit with the radiation unit.
The detection unit(s) and the radiation unit(s) may be placed side by side on a rigid or flex PCB.
The driver(s) may be soldered/placed together on the same PCB.
The detection unit(s) and the radiation unit(s) may be built on the same CMOS chip. The wafer level integration enables the detection unit(s) and the radiation unit(s) optical systems to be implemented with the same wafer level technology. The CMOS IC may be used for readout of the detection unit(s) as well as driving of the radiation unit(s). This integrated solution benefits from wafer level packaging (WLP). This integrated concept (common CMOS IC) can be similarly extended to different numbers, combinations and types of radiation unit(s) and detection unit(s).
The eye tracker module may include an aperture letting the radiation transmit from the radiation unit(s) to the target.
The eye tracker module may include an aperture letting the light transmit from the target to the detection unit(s).
The eye tracker module can be placed/soldered on a flex PCB to be easily implemented and integrated on different AR/VR-glasses or head-mounted display devices.
The eye tracker module may be placed onto the AR/VR glasses or head-mounted display devices at least as a single unit per eye.
The eye tracker module can be placed to see the full eyeball considering the tolerances of the position of the glasses in extreme cases of the slippage of the glasses.

The eye tracker method that enables pupil center detection is, for example, executed using with the specified eye tracker module:
The eye tracker module, e.g. with the flex PCB, which can be placed on a display device may be electrically interfaced to the host for pupil center detection and pupil tracking.
In order to initiate the eye tracking method, an eye image or sequence of images or videos can be captured. In order to capture an image, the detection unit(s) may trigger the driver(s) to let the radiation unit(s) illuminate the eye.
The radiation unit(s) may illuminate the eye with at least one 2D-structured pattern that is well defined and focused within the operation distance range of the eye tracker module. The reflected radiation from the eye can be captured with the detection unit(s) that are placed in close proximity to the radiation unit(s). This configuration enables the Lambertian reflections from the eye to be captured, even for the extreme eye and pupil locations. The Lambertian reflections are mainly captured from the iris and the sclera region of the eye as corneal structure introduces mainly specular reflections. Thus, the detection unit only or mainly captures Lambertian reflections from the eye rather than the specular reflections.
The detection unit(s) may be dedicated to capture images of the eye illuminated with the 2D-structured pattern in the operation distance range of the use case. After capturing these images, these images are transferred to a host (i.e. the processor) for calculating the gaze information. Pupil center location may be mapped to the display device through user calibration procedure.
From the captured images of the 2D-structured pattern as reflected by the eye, different dedicated algorithms may be utilized for finding the center of the pupil. Particularly, this method relies on the missing projection pattern features on the pupil region (thanks to exploitation of the Lambertian reflections), if one compares the captured image with a reference image of a 2D-structured pattern.
In an example for the suggested method the eye is illuminated with a 2D-dot pattern. The 2D-dot pattern has M×N dots in an M×N configuration. A portion of the 2D-dot pattern is transmitted through the pupil of the user. This results in missing dots in the pupil area of the eye. The locations of the missing dots (e.g. dotᵢ, j . . . dotᵢ+2, j+2) on the pupil regions can be used in order to find the center of pupil. In order to find the center of the pupil, many different approaches can be used from these missing dots such as:
   Center of the mass (or so called image intensity) of missing dots based on the dot location with the help of a lookup table.
   Center of the mass (or so called image intensity) of missing dots based on the dot intensity values by the help of a look up table.
   The difference image of the captured image and the reference image showing the full pattern obtained during calibration.
   Dynamic modulation of the projected dot-pattern and dynamic readout at the modulation frequency enables the image to be captured, which only contains the reflected dot pattern from the eye without any eye features. This image can be used for image subtraction with the reference image of the full pattern obtained during calibration.
   Interpolation of the missing dot locations weighted with overall dot intensity absorbed in the pupil. So in the case that one dot is fully absorbed, it should have a larger weight and effect in the pupil center computation, if this is compared with a dot that is half absorbed.
   Cross-correlation and inverted cross-correlation of the captured image with the reference image of full pattern obtained during calibration. These methods can be used to highlight the missing features from the reference images.
The selected method from the listed methods can be chosen depending on the trade-offs between pupil detection accuracy and computational complexity, speed and power.
The above listed methods can be applied to any other 2D structured-pattern (e.g. square pattern, line pattern etc.).
The detected pupil center may be matched and synchronized with the display pixels of the display device and the location of the virtual content. Depending on the missing dot location or pupil center location, the display content can be adjusted or steered. This is significantly important for applications such as foveated rendering and for power optimization of the near eye display devices.
The eye tracking method can be applied continuously to upcoming images from the detection unit in order to enable continuous detection of the pupil center with every eye position. By utilizing continuous and real time detection, the pupil tracking may be enabled.

A calibration method is specified:
In order to enable pupil tracking with the proposed eye tracker module, both factory and user calibration data may be used. To this aim, factory calibration and user-specific calibration routines may be performed.
Factory calibration:
   For the proposed eye tracker module, a dedicated calibration procedure may be implemented in order to cover the target distance range for the use case and application. This includes resizing and structuring the calibration targets, capturing images at the dedicated target distances, and producing calibration files for this target distance.
   A reference calibration image with the 2D-structured pattern may be captured to be used in the eye tracking method. A flat target or circular eye-like objects may be used to capture and form this reference image.
   The captured reference image(s) may be processed or optimized for the target distance range, geometry and the use case.
   Detection unit (e.g. camera) calibration may be required. This procedure includes the estimation of detection unit intrinsics (mainly imaging lens and sensor parameters, such as focal length of the lens(es), resolution of the sensor, distortion parameters etc.) and detection unit extrinsics (the location and the orientation of the detection unit(s) and the radiation unit(s) ) parameters). These parameters can be used to undistort the image as well as to pre-process the captured reference image.
   The calibration reference image(s) and calibration files may be stored in a memory.
User calibration:
   The calibration may be performed with the display device, e.g. the AR/VR glasses or the head-mounted display device.
   The stimuli (i.e. markers) for the calibration can be presented to the user. The user is asked to look at or to follow these markers. While the user is looking at these markers (e.g. fixation), the image(s) of the 2D-structured as reflected by the eye at this fixation point can be captured.
   For every fixation point, the eye tracking method may be performed, e.g. based on the location of the missing projection features. This gaze information (e.g. missing feature locations) may be matched with the location of the content on the display (e.g. may be based on display pixel location, may be based on display's illuminator location, etc.).
   Parameters relating to the dot location with the display location (e.g. conversion factor) may be computed, extracted and stored to be used during real time pupil detection.
   The user calibration parameters or the output of the user calibration such as the conversion factor may be kept in a memory for continuous and real time eye tracking and for synchronization of the pupil center location with the near display content.
   The user calibration may be an N point calibration (i.e. N point stimuli).
   Single point calibration (i.e. one point stimulus) may be optional to speed up the calibration process.
   The calibration may be done with single or both eyes by using the display device.
   All output data related to calibration procedure may be kept in the memory of the eye tracker module or of the display device.

Hereinafter, the eye tracker module, the eye tracking method, the eye tracking system, the display device and the method for operating a display device will be explained in more detail with reference to the drawings on the basis of exemplary embodiments. The accompanying figures are included to provide a further understanding. In the figures, elements of the same structure and/or functionality may be referenced by the same reference signs. It is to be understood that the embodiments shown in the figures are illustrative representations and are not necessarily drawn to scale. In so far as elements or components correspond to one another in terms of their function in different figures, the description thereof is not repeated for each of the following figures.

For the sake of clarity, elements might not appear with corresponding reference symbols in all figures.

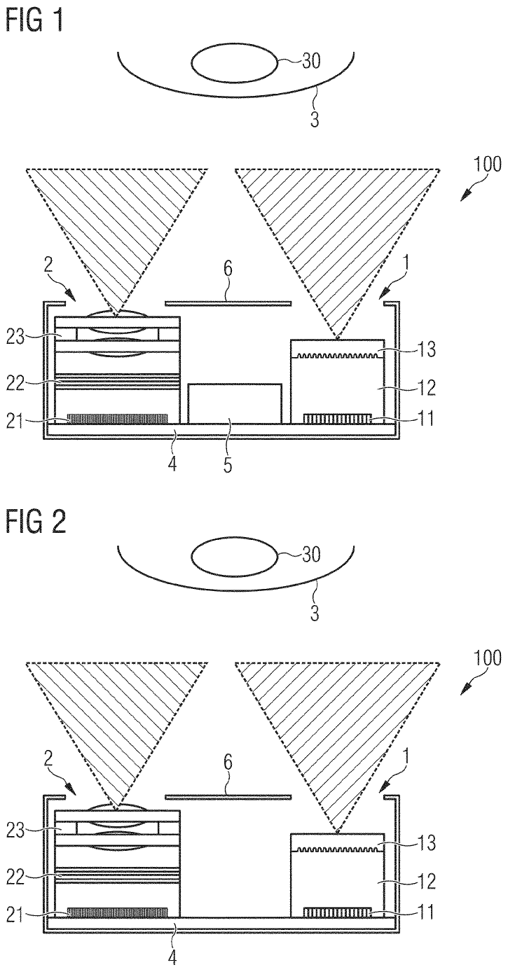

FIGS. 1 to 4 show different exemplary embodiments of the eye tracker module and the eye tracker system,

FIG. 5 shows a flowchart of an exemplary embodiment of the eye tracking method,

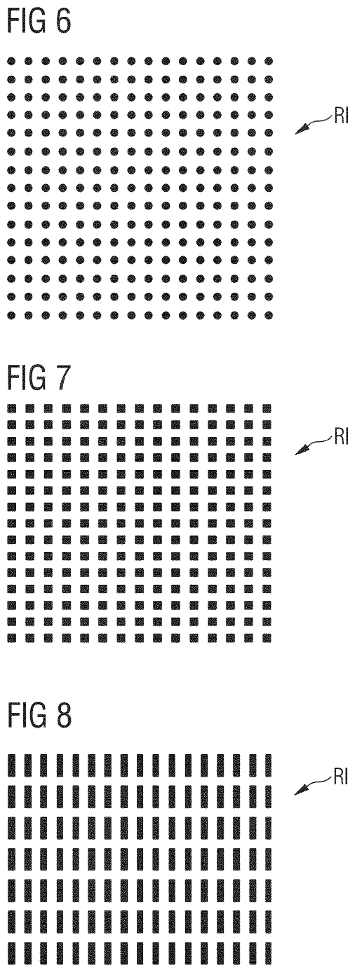

FIGS. 6 to 8 show different exemplary embodiments of a 2D-structured pattern,

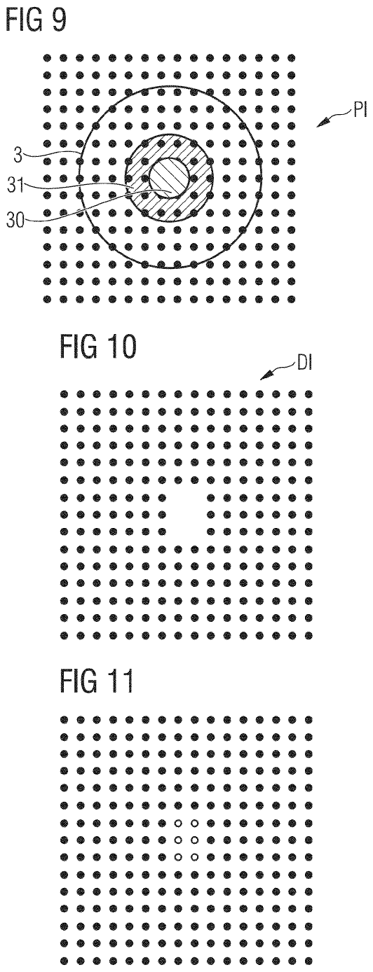

FIGS. 9 to 11 show different positions in an exemplary embodiment of the eye tracking method,

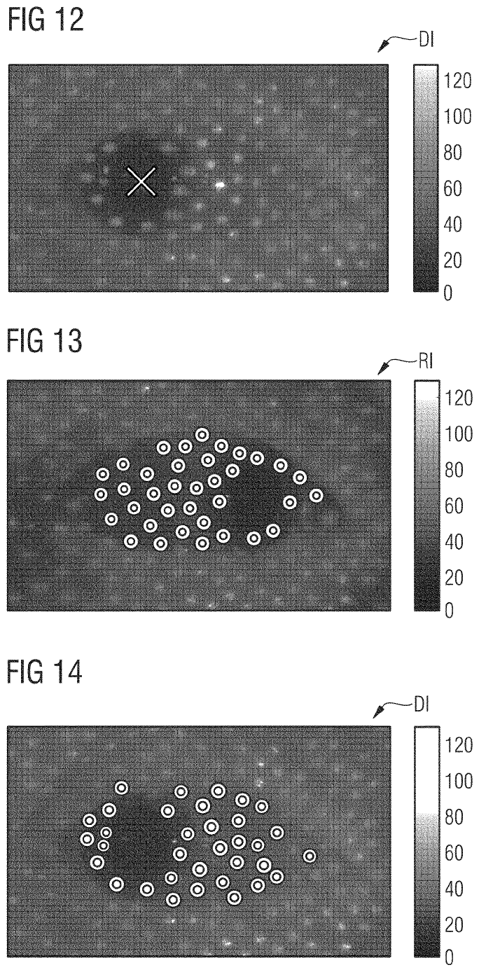

FIGS. 12 to 15 show different positions in a further exemplary embodiment of the eye tracking method,

FIG. 16 shows an exemplary embodiment of the display device,

FIGS. 17 to 19 show a flowchart and different positions in an exemplary embodiment of a method for calibrating a display device.

FIG. 1 shows an exemplary embodiment of an eye tracker module 100 which comprises a carrier 4 which may be a rigid or flexible PCB. A control unit 5, also referred to as driver, is mounted on a top side of the carrier. Furthermore, a radiation unit 1 and a detection unit 2 are mounted on the top side of the carrier 4. The components 1, 2 and 5 may be electrically connected to the carrier 4.

Moreover, the eye tracker module 100 comprises a housing 6, which laterally surrounds the radiation unit 1 and the detection unit 2. Two apertures are formed in the housing 6 at its top side through which radiation can exit or enter, respectively, the eye tracker module 100.

The radiation unit 1 is a projector and is configured to illuminate an eye 3 of a user with radiation. The radiation unit 1 comprises a radiation source 11 in the form of a VCSEL array. A micro lens array 13 is arranged downstream of the radiation source 11 and is spaced apart from the radiation source 11 by a spacer 12. With the help of the VCSEL array 11 and the micro lens array 13, a 2D-structured pattern, as for example illustrated in connection with FIGS. 6 to 8, may be projected onto the eye 3 of a user when the eye is at a nominal operation distance to the eye tracker module 100.

The detection unit 2 is a camera and is configured to capture an image of the eye 3 by detecting radiation originally stemming from the radiation unit 1 and reflected at the eye 3. The detection unit 2 comprises an image sensor 21, e.g. a CMOS sensor, a lens system 23 upstream of the image sensor 21 and a filter 22 upstream of the image sensor 21. The lens system 23 projects the radiation reflected at the eye 3 onto the image sensor 21. The filter 22 is, for example, configured to let pass radiation of a certain wavelength range which matches with the wavelength range emitted by the radiation unit 1 and reflects or absorbs radiation outside this certain wavelength range, e.g. ambient light.

The eye tracker module 100 of FIG. 1 is a compact package which, as a whole or as a unit, can be mounted and securely connected to a display device. For example, a pitch between the detection unit 2 and the radiation unit 1 is at most 10 mm. The lateral extensions of the radiation unit 1 and the detection unit 2 may each be at most 2 mm×2 mm. The footprint of the whole eye tracker module 100 may be at most 100 mm².

The control unit 5 of FIG. 1 is, for example, configured to operate the radiation unit 1 and the detection unit 2. Additionally, it may be configured to determine a gaze information and an output signal comprising the gaze information. Particularly, the eye tracker module 100 of FIG. 1 is at the same time an exemplary embodiment of the eye tracker system. The control unit 5 may also comprise a memory for storing captured images and/or reference images and/or the determined gaze information.

In a special embodiment of the eye tracker module 100 of FIG. 1, the radiation unit 1 is an AC-coupled projector, which is operated by the control unit 3 in a pulsed mode. Thus, the eye 3 is illuminated with a time-modulated 2D-structured pattern and the reflected modulated radiation is captured with the detection unit 2. The modulation frequency of the radiation unit 1 is f mod, for example. The radiation unit 2 readout implementation is also AC-coupled, which is aimed to detect the information at the modulation frequency f_mod. Lock-in based video processing methods can be used to extract the modulation information. This enables easy registration of the features in the 2D-structured pattern as reflected by the eye 3 and the removal of the background image of the eye. Advantages thereof are low noise, high SNR and low power consumption. A movement of the pupil with a new gaze vector can be extracted from only the information about the detected 2D-structured image without using the background eye image. As the gaze vector changes, the orientation of the detected features changes. This change can be detected by using frame subtraction. Alternatively it can also be detected by means of a lookup table.

FIG. 2 shows a second exemplary embodiment of the eye tracker module 100 which is similar to that of FIG. 1. In contrast to FIG. 1, however, the eye tracker module 100 of FIG. 2 does not comprise a control unit for operating the radiation unit 1 and the detection unit 2. In contrast to FIG. 1, the eye tracker module 100 of FIG. 2 is also not configured to determine a gaze information and to generate a corresponding output signal. The operation of the units 1 and 2 and the determination of the gaze information may be done by an external control unit/processor, which is for example part of the display device to which the eye tracker module 100 is mountable.

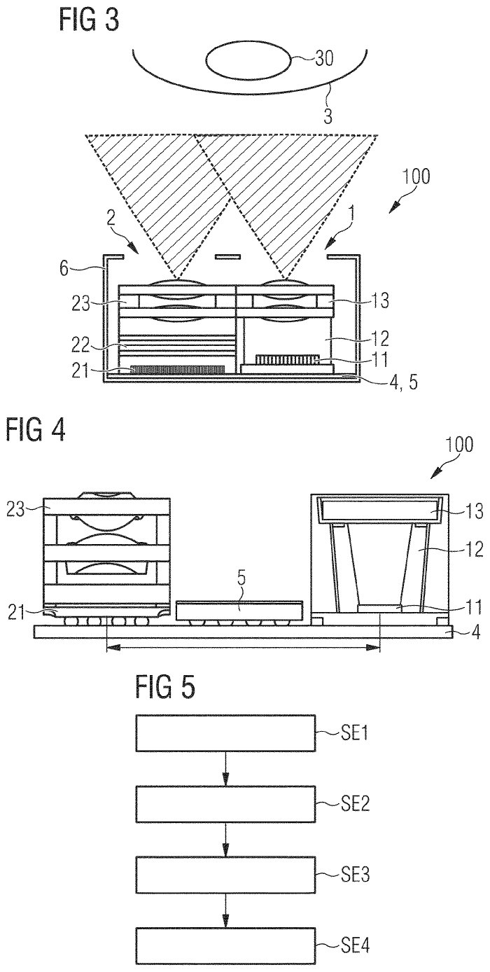

FIG. 3 shows a further exemplary embodiment of the eye tracker module 100 being an eye tracker system. In this case, the carrier 4 is a CMOS chip or a CMOS substrate on which both the radiation unit 1 and the detection unit 2 are mounted. The carrier 4 constitutes, at the same time, the control unit 5 for operating the radiation unit 1 and the detection unit 2 as well as for determining the gaze information. The wafer level integration enables implementation of the camera 23 and the projector 13 optics with the same wafer level technology. This integrated solution benefits from wafer level packaging (WLP) and very small package size as this is an especially compact solution. Similarly, the integrated concept (common CMOS chip) can be extended to one camera 2 and two projectors 1 on the same CMOS chip, a camera 2 and a and a projector configured as a self-mixing interferometer (SMI) on the same CMOS chip or multiple cameras 2 and multiple projectors 1.

FIG. 4 shows a further exemplary embodiment of the eye tracker module 100. The double arrow indicates the pitch/baseline between the radiation unit 1 and the detection unit 2.

FIG. 5 shows an exemplary embodiment of the eye tracking method in a flowchart. For executing this method, the eye tracker module 100 according to any of the preceding exemplary embodiments may be used. In step SE1, a 2D-structured pattern is projected onto an eye of a user by using the radiation unit 1. In step SE2, an image of the 2D-structure pattern as reflected at the eye is captured using the detection unit 2. In a step SP3, a gaze information, being representative for the location of the center of the pupil 13 of the eye, is determined depending on the captured image, particularly based on missing features in the captured image. In step SE4, an output signal is generated which comprises the gaze information.

FIGS. 6 to 8 show different (reference) images RI of 2D-structured patterns. They are achieved, for example, when the radiation of the radiation unit is projected onto a uniformly formed flat surface and an image of this surface is captured.

In FIG. 6, a regular 2D-dot pattern is shown. In FIG. 7, a regular 2D-square pattern is shown and in FIG. 8 a regular 2D-stripe pattern is shown.

FIG. 9 shows an exemplary embodiment of an eye 3 of the user onto which a 2D-dot pattern PI is projected. The eye 3 has a pupil 30 and an iris 31.

FIG. 10 shows an exemplary embodiment of a captured image DI of the 2D-dot pattern PI as reflected by the eye 3. As can be seen, some of the features, namely the dots, of the 2D-dot pattern are missing in the captured image DI. These missing dots can be identified by comparing the captured image DI with a reference image RI (e.g. that of FIG. 6) as is illustrated in FIG. 11. The missing dots are indicated by the open circles. By using the information about the location of these missing dots, the center of the pupil 31 may be determined to be the radiance-weighted centroid of the missing dots, for example.

FIG. 12 shows an actual captured image DI of an eye of a user during illumination with a 2D-dot pattern. Indeed, no dots are reflected in the region of the pupil. The center of these missing dots is indicated by the white cross.

FIG. 13 shows a reference image RI, which may be used for determining the center of the pupil. In this reference image, several features are visible in the form of dots. The dots in the region of the eye are highlighted. In this case, the reference image RI is an actual captured image of the eye when illuminated with a 2D-dot pattern. This reference image RI is, for example, repeatedly updated based on previously captured images.

FIG. 14 shows a captured image of the 2D-dot pattern as reflected from the eye at a moment in time after the image RI of FIG. 13 has been captured. Again, dots are reflected from the eye in the region outside of the pupil.

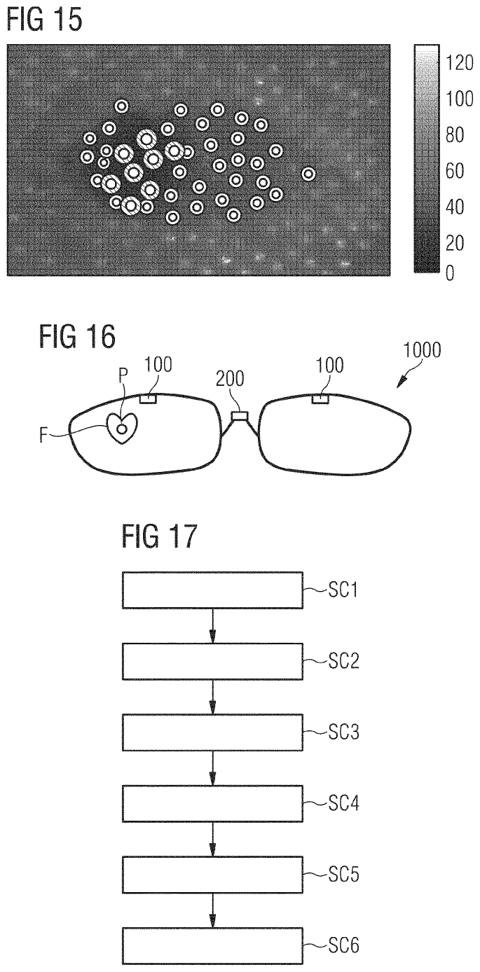

FIG. 15 shows a comparison between the captured image DI of FIG. 14 and the reference image RI of FIG. 13. From the comparison of the two images, the dots which are present in the reference image RI but which are missing in the captured image DI can be determined. These “missing dots” are indicated by the larger circles. The position of these larger circles may then again be used to determine the center of the pupil, e.g. by determining the radiance-weighted centroid or by extrapolation.

FIG. 16 shows an exemplary embodiment of a display device 1000. The display device 1000 is a pair AR-glasses. The display device 1000 comprises two eye tracker modules 100 mounted to the display device 1000, wherein each eye of a user is assigned one of the eye tracker modules 100. Furthermore, the display device 100 comprises a processor or host 200, which is configured to operate the display device 1000 such that a visible feature F is presented to the user. The eye tracker modules 100 and the processor 200 are signally coupled so that the information provided by the eye tracker modules 100, particularly the captured images and/or the gaze information, is transmitted to the processor 200. For example, from the gaze information determined by the eye tracker modules 100, the processor 200 determines the position P at which the user of the display device 100 is looking (point of gaze) and the processor 200 accordingly operates the display device 1000 such that an information, in the form of the feature F, is presented to the user at the position P at which he/she is currently looking.

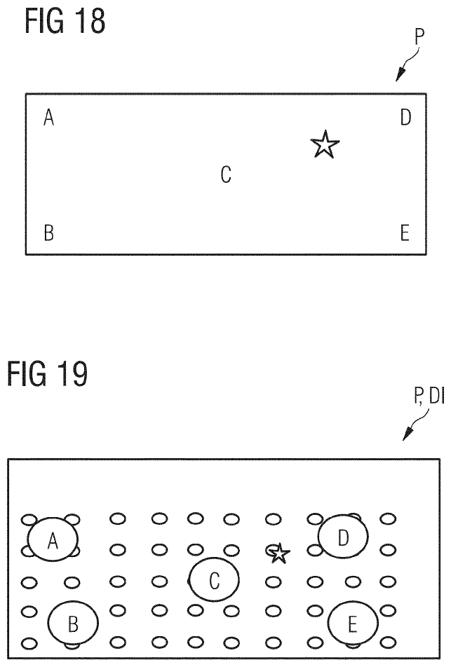

FIG. 17 shows a flowchart of an exemplary embodiment of a method for calibrating a display device. FIGS. 18 and 19 show different scenes/positions during this method. The method may be executed with the display device 1000 of FIG. 16. In a step SC1, a 2D-structured pattern is projected onto an eye or the eyes of a user using the display device. In step SC2 the user is asked to look at different features F, e.g. labeled as A, B, C, D, E, presented by the display device (see FIG. 18). In step SC3, an image of the 2D-structured pattern as reflected by the eye(s) is captured (see FIG. 19). In step SC4, the location of pupil center is determined and the determined location is matched with the pixels of the display device. In step SC5, calibration information (e.g. parameters) is determined which relates the dot locations with the display device. In step SC6, this calibration information is sent to a memory, where it is stored.

This patent application claims the priority of the German patent application 102023103688.2, the disclosure of which is hereby incorporated by reference.

The invention described herein is not limited by the description in conjunction with the exemplary embodiments. Rather, the invention comprises any new feature as well as any combination of features, particularly including any combination of features in the patent claims, even if said feature or said combination per se is not explicitly stated in the patent claims or exemplary embodiments.

### REFERENCES

1 radiation unit/projector
2 detection unit/camera
3 eye
4 carrier
5 control unit
6 housing
11 radiation source
12 spacer
13 lens/micro lens array
21 image sensor
22 filter
23 lens system
30 pupil
31 iris
100 eye tracker module
200 processor
1000 display device
SE1 . . . SE4 method steps
SC1 . . . SC6 method steps
PI 2D-dot pattern
RI reference image
DI captured image
P point of gaze
F information/feature

1. An eve tracker module comprising:
a radiation unit; and
a detection unit), wherein
the radiation unit is configured to project a 2D-structured pattern onto an eye of a user, wherein
the detection unit is configured to capture an image of the 2D-structured pattern as reflected by the eye, wherein
the eye tracker module comprises a housing and the housing laterally surrounds the radiation unit and the detection unit.

2. The eye tracker module according to claim 1, wherein
the radiation unit is configured to project a 2D-dot pattern and/or a 2D-square pattern and/or a 2D-stripe pattern and/or a 2D-ellipse pattern onto the eye.

3. The eye tracker module according to claim 1, wherein the radiation unit comprises a micro lens array.

4. The eye tracker module according to claim 1, wherein
the radiation unit comprises at least one VCSEL.

5. The eye tracker module according to claim 1, wherein
the eye tracker module is formed as a package which is mountable to a display device and is signally connectable to the display device

6. The eye tracker module according to claim 1, wherein
the radiation unit and the detection unit are arranged such that, with the eye tracker module being at a nominal operation position with respect to an eye of a user, the radiation from the radiation unit being reflected by the eye and then being detected by the detection unit mainly results from Lambertian reflections at the eye

7. The eye tracker module according to claim 1, wherein
the radiation unit and the detection unit are mounted on a common carrier of the eye tracker module.

8. The eye tracker module according to claim 7, wherein
the common carrier is a common circuit board or a common CMOS chip.

9. The eye tracker module according to claim 1, further comprising
a control unit for operating the radiation unit and/or the detection unit.

10. A display device comprising
at least one eye tracker module according to claim 1, wherein
the display device is configured to present a visible information to the user of the display device.

11. An eye tracking method comprising
projecting a 2D-structured pattern onto an eye of a user with the help of a radiation unit,
capturing an image of the 2D-structured pattern as reflected by the eye with the help of a detection unit,
determining a gaze information depending on the captured image, wherein the gaze information is representative for the location of the pupil of the eye, wherein
determining the gaze information comprises comparing the captured image with a reference image, wherein the reference image is an image of a 2D-structured pattern; and
updating the reference image depending on at least one image captured previously with the help of the detection unit.

12. The eye tracking method according to claim 11, wherein
the radiation unit and the detection unit are arranged such that the radiation from the radiation unit detected by the detection unit mainly results from Lambertian reflections at the eye.

13. (canceled)

14. The eye tracking method according to claim 11, wherein
determining the gaze information comprises identifying locations of features in the reference image for which corresponding features in the captured image have a radiance below a threshold or which are missing in the captured image of the reflected 2D-structured pattern in order to determine the location of the pupil.

15. (canceled)

16. The eye tracking method according to claim 11, wherein
the radiation unit is operated in a pulsed mode,
determining the gaze information is done depending on images captured in accordance with the pulsed mode.

17. A method for operating e-the display device according to claim 10, the method comprising
projecting a 2D-structured pattern onto an eye of a user with the help of the radiation unit,
capturing an image of the 2D-structured pattern as reflected by the eye with the help of the detection unit,
determining a gaze information depending on the captured image, wherein the gaze information is representative for the location of the pupil of the eve, wherein determining the gaze information comprises comparing the captured image with a reference image, wherein the reference image is an image of a 2D-structured pattern;
updating the reference image depending on at least one image captured previously with the help of the detection unit; and
presenting a visible information to the user of the display device depending on the determined gaze information.

18. An eye tracker system comprising:
a radiation unit which is configured to project a 2D-structured pattern onto the eye of a user; and
a detection unit which is configured to capture an image of the 2D-structured pattern as reflected by the eye,
wherein
the eye tracker system is configured to:
determine a gaze information depending on the captured image, wherein the gaze information is representative of the location of the pupil of the eye, wherein
the eye tracker system configured to determine the gaze information comprises the eye tracker system configured to: compare the captured image with a reference image, wherein the reference image is an image of a 2D-structured pattern; and
update the reference image depending on at least one image captured previously with the help of the detection unit.

19. A computer program comprising instructions to cause the eye tracker system of claim 18 to execute the steps of:
projecting a 2D-structured pattern onto an eve of a user with the help of the radiation unit;
capturing an image of the 2D-structured pattern as reflected by the eve with the help of the detection unit;
determining a gaze information depending on the captured image, wherein the gaze information is representative for the location of the pupil of the eye, wherein determining the gaze information comprises comparing the captured image with a reference image, wherein the reference image is an image of a 2D-structured pattern, and
updating the reference image depending on at least one image captured previously with the help of the detection unit.

20. A non-transitory computer-readable medium comprising instructions that, when executed by one or more processors, cause the one or more processors to execute the computer program of claim 19 stored thereon.
